(19) United States
(12) Patent Application Publication
(10) Pub. No.: US 2013/0304402 A1
(43) Pub. Date: Nov. 14, 2013

(54) ANALOG INPUT UNIT AND PROGRAMMABLE CONTROLLER

(71) Applicants: Satoru Ukena, Chiyoda-ku (JP); Hironori Kameoka, Chiyoda-ku (JP); Yuji Makimoto, Chiyoda-ku (JP)

(72) Inventors: Satoru Ukena, Chiyoda-ku (JP); Hironori Kameoka, Chiyoda-ku (JP); Yuji Makimoto, Chiyoda-ku (JP)

(73) Assignee: MITSUBISHI ELECTRIC CORPORATION, Chiyoda-ku, Tokyo (JP)

(21) Appl. No.: 13/978,002

(22) PCT Filed: Jan. 21, 2011
(86) PCT No.: PCT/JP2011/051096

§ 371 Date: Jul. 2, 2013

(51) Int. Cl. G01F 9/00

(52) U.S. Cl. CPC G01F 9/008
USPC 702/45

(57) ABSTRACT

An analog input unit configured to be included in a programmable controller and to sequentially convert analog values input from outside into digital values, the analog input unit includes: an analog-to-digital conversion unit that converts an analog value being a measurement value of a flow meter into a digital value; a flow computation unit that calculates an instantaneous flow and a total integrated flow that is obtained by integrating a flow per setting time set in advance, based on the digital value from the analog-to-digital conversion unit; and a storage unit that includes a flow storage area for storing therein the instantaneous flow and the total integrated flow calculated by the flow computation unit.

### FIELD

The present invention relates to an analog input unit and a programmable controller including an analog input unit.

### BACKGROUND

When flow data obtained by measurement with a flow meter are loaded to a programmable controller (PLC), an analog input unit (A/D conversion unit) is used, which converts an analog value input as a measurement value of the flow meter into a digital value. Many of flow meters output an instantaneous flow (an instantaneous value) as the measurement value. Conventionally, when performing flow management with a PLC, the measurement value is received at a timing corresponding to a sampling period of the flow meter and the instantaneous value is converted into a flow per predetermined time to integrate the flow by using a user program.

Generally, the sampling period of the flow meter and a processing period (a scan time) of a CPU unit that controls the entire PLC are asynchronous with each other. Furthermore, a flow meter has been developed, which is configured to measure a flow in a sampling period shorter than the processing period of the general CPU unit. For this reason, even when a conversion speed of the analog input unit can keep pace with the sampling period of the flow meter, there may be a case where the high speed of the analog input unit is not fully utilized because an interval for collecting flow data is determined by the processing period of the CPU unit.

As techniques related to this problem, for example, a technique capable of collecting data in a predetermined period without depending on the scan time of a sequence program (see, for example, Patent Literature 1) and a technique capable of performing various types of processing treatment on collected data (see, for example, Patent Literature 2) have been proposed. In addition, an apparatus that calculates an integrated value with a measurement instrument and stores the value therein (see, for example, Patent Literature 3) and a system that monitors a signal transmitted from a flow meter according to a predetermined flow and calculates an integrated amount (see, for example, Patent Literature 4) have been proposed.

### CITATION LIST

### Patent Literatures

Patent Literature 1: Japanese Patent Application Laid-open No. 4-288602
Patent Literature 2: Japanese Patent Application Laid-open No. 2000-122706
Patent Literature 3: Japanese Patent Application Laid-open No. 2008-58006
Patent Literature 4: Japanese Patent Application Laid-open No. 5-164591

### SUMMARY

### Technical Problem

For example, if the technique disclosed in Patent Literature 1 and the technique disclosed in Patent Literature 2 are used in a combined manner, data collection in a predetermined period and processing of the collected data into the flow can be performed. In this case, because an analog unit does not include a unit that converts the instantaneous value into a flow per predetermined time to integrate the flow and a unit that stores therein the integrated value, such processes are still performed by using a user program. Furthermore, the analog input unit does not even include a unit that records therein a flow per predetermined time (for example, per hour or per day).

Both the technique disclosed in Patent Literature 3 in which the flow meter integrates the measurement value and the technique disclosed in Patent Literature 4 in which a signal from the flow meter is received to integrate the measurement value do not include a unit that manages the flow with a PLC, and thus these techniques cannot be applied as they are to flow management through conversion from the analog value into the flow and an integration of the flow.

The present invention has been made in view of the above problems, and an object of the present invention is to obtain an analog input unit and a programmable controller that enable easy flow management and abnormality detection with a PLC.

### Solution to Problem

To solve the problems and achieve the object according to an aspect of the present invention, an analog input unit configured to be included in a programmable controller and to sequentially convert analog values input from outside into digital values, the analog input unit includes: an analog-to-digital conversion unit that converts an analog value being a measurement value of a flow meter into a digital value; a flow computation unit that calculates an instantaneous flow and a total integrated flow that is obtained by integrating a flow per setting time set in advance, based on the digital value from the analog-to-digital conversion unit; and a storage unit that includes a flow storage area for storing therein the instantaneous flow and the total integrated flow calculated by the flow computation unit.

### Advantageous Effects of Invention

The analog input unit according to the present invention is configured to calculate an instantaneous flow and a total integrated flow with a flow computation unit, thereby obtaining the integrated flow and the instantaneous flow while utilizing a high speed and a high periodicity of the analog input unit. Thus an easy flow management and abnormality detection with a PLC becomes possible.

### BRIEF DESCRIPTION OF DRAWINGS

FIG. 1 is a block diagram of a configuration of a PLC system including an analog input unit according to an embodiment of the present invention.

FIG. 2 is an explanatory diagram of a data structure of a parameter storage area.

FIG. 3 is an explanatory diagram of a data structure of a flow storage area.

FIG. 4 is an explanatory diagram of a data structure of a daily-report-data storage area.

FIG. 5 is a flowchart for explaining an operation procedure of the analog input unit.

FIG. 6 is an explanatory diagram of errors that may occur due to an integration of a flow per integration period.

FIG. 7 is an explanatory diagram of a compensation performed when a flow is increased within an integration period.

FIG. 8 is an explanatory diagram of a compensation performed when a flow is decreased within an integration period.

FIG. 9 is a flowchart for explaining a procedure performed from acquisition of an integrated flow for every hour to storage of a daily-report data file.

FIG. 10 is an example of a CSV file.

### DESCRIPTION OF EMBODIMENTS

Exemplary embodiments of an analog input unit and a programmable controller according to the present invention will be explained below in detail with reference to the accompanying drawings. The present invention is not limited to the embodiments.

### Embodiment

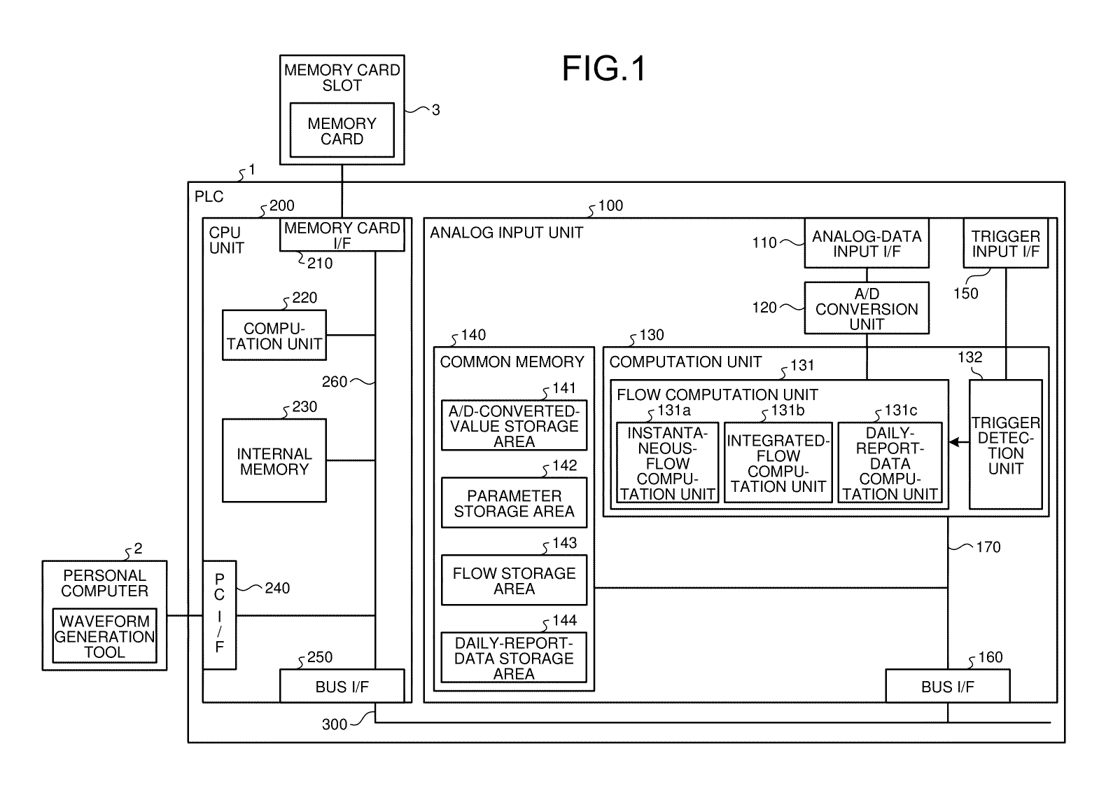

FIG. 1 is a block diagram of a configuration of a PLC system including an analog input unit according to an embodiment of the present invention. The PLC system is a system including a PLC 1 and peripheral devices connected to the PLC 1. For example, a personal computer 2 and a memory card slot 3 are peripheral devices included in the PLC system.

An analog input unit 100 is connected to a CPU unit 200 via an inter-unit bus 300. The analog input unit 100 and the CPU unit 200 constitute a part of the PLC 1. In the PLC 1, various units (not shown) for desired purposes, in addition to the analog input unit 100 and the CPU unit 200, are installed via the inter-unit bus 300.

As the various units, for example, a motion controller unit that performs a position control in multi-axes by a servo amplifier and a temperature controller unit that outputs a temperature control signal for controlling heating or cooling such that a temperature instructed by the CPU unit 200 is reached are installed in the PLC 1. Among the various units, explanations of units other than the analog input unit 100 and the CPU unit 200 are omitted.

The analog input unit 100 receives an input of an analog value from outside to the PLC 1, and sequentially converts input analog values into digital values. Various measurement values related to an industrial apparatus or the like, which is to be controlled by the PLC 1, such as a flow, a pressure, and a temperature, are converted into analog current values or voltage values and are input to the analog input unit 100 from various sensors.

The analog input unit 100 includes an analog-data input interface (I/F) 110, an analog-to-digital (A/D) conversion unit 120, a computation unit 130, a common memory (storage unit) 140, a trigger input interface (I/F) 150, and a bus interface (I/F) 160.

The analog-data input I/F 110 receives the input of the analog value. The A/D conversion unit 120 converts the analog value into a digital value (an A/D converted value). The computation unit 130 performs a control of the entire analog input unit 100. The common memory 140 stores therein the A/D converted value from the A/D conversion unit 120 and a computation result from the computation unit 130. The common memory 140 is accessible by the CPU unit 200 to read out data via the inter-unit bus 300, as well as being accessible by the computation unit 130 to read and write data.

The trigger input I/F 150 receives a trigger for starting and ending an integration of the flow. The bus I/F 160 is a communication interface for performing a communication with the CPU unit 200 via the inter-unit bus 300. The computation unit 130, the common memory 140, and the bus I/F 160 are connected to each other via an internal bus 170.

The PLC 1 is configured to receive, for example, the following types of requests, as the trigger for starting and ending the integration of the flow.
Request by a command issued from the CPU unit 200
Request by an internal signal of the PLC 1
Request by an input signal to the trigger input I/F 150

The CPU unit 200 repeats execution of a user program, which is a program for controlling the industrial apparatus by operating the various units included in the PLC 1, output of an execution result, and acquisition of an input value such as a value used in the user program, in a predetermined period. This repeated operation is referred to as a “cyclic process”. The CPU unit 200, as a part of an input-value acquisition operation included in the cyclic process, reads out the digital value (the A/D converted value) from the common memory 140.

The CPU unit 200 includes a memory card interface (I/F) 210, a computation unit 220, an internal memory 230, a personal computer interface (PC I/F) 240, and a bus interface (I/F) 250.

The memory card I/F 210 is an interface for accessing a memory card set in the memory card slot 3. The memory card stores therein a user program, data required to execute the user program, and data of an execution result of the user program. The computation unit 220 performs an execution of the user program and a control of the entire CPU unit 200.

The internal memory 230 stores therein data required to execute the user program, and input and output values of the user program. The PC I/F 240 is an interface for connecting to the personal computer 2. The personal computer 2 displays a setting of the user program and the information stored in the internal memory 230. Furthermore, the personal computer 2 generates a signal waveform by using a waveform generation tool.

The bus interface (I/F) 250 is an interface for performing a communication with the analog input unit 100 via the inter-unit bus 300. The memory card I/F 210, the computation unit 220, the internal memory 230, the PC I/F 240, and the bus I/F 250 are connected to each other via an internal bus 260.

The common memory 140 includes an A/D-converted-value storage area 141, a parameter storage area 142, a flow storage area 143, and a daily-report-data storage area 144. The A/D-converted-value storage area 141 stores therein the A/D converted value from the A/D conversion unit 120. The A/D converted value is read out from the A/D-converted-value storage area 141 by the cyclic process of the CPU unit 200.

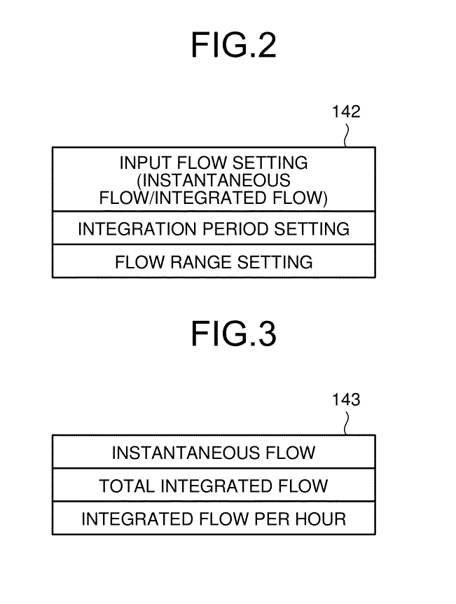

FIG. 2 is an explanatory diagram of a data structure of the parameter storage area. The parameter storage area 142 stores therein parameters of an input flow setting, an integration period setting, and a flow range setting. The input flow setting is a type of the measurement value output from the flow meter, which is set to either an instantaneous flow (an instantaneous value) or an integrated flow (an integrated value). The instantaneous flow represents an amount of a substance to be measured, which passed the flow meter at a certain moment. The integrated flow represents an amount of the substance to be measured, which passed the flow meter for a certain period of time. As the flow meter, a flow meter that outputs the instantaneous value and a flow meter that outputs the integrated value have been developed. In the present embodiment, the flow meter may be either the flow meter that outputs the instantaneous value or the flow meter that outputs the integrated value.

The parameter of the integration period setting represents a setting time set as a period for integrating the flow in the analog input unit 100. The parameter of the flow range setting represents a range of the measurement value output from the flow meter. The parameters stored in the parameter storage area 142 are set, for example, by an input operation of a user.

FIG. 3 is an explanatory diagram of a data structure of the flow storage area. The flow storage area 143 stores therein the instantaneous flow calculated based on the A/D converted value from the A/D conversion unit 120, a total integrated flow obtained by integrating a flow per integration period, and a flow per hour (an integrated flow for every hour).

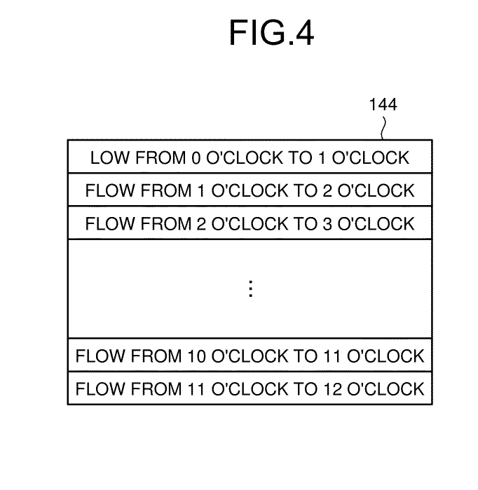

FIG. 4 is an explanatory diagram of a data structure of the daily-report-data storage area. The integrated flows for every hour calculated for a day are collected and stored in the daily-report-data storage area 144 as daily report data (“flow from 0 o'clock to 1 o'clock”, . . . , “flow from 11 o'clock to 12 o'clock”).

Referring back to FIG. 1, the computation unit 130 includes a flow computation unit 131 and a trigger detection unit 132. The trigger detection unit 132 detects a trigger for starting or ending the integration of the flow. The flow computation unit 131 converts the A/D converted value from the A/D conversion unit 120 into a flow and writes the flow in the flow storage area 143, based on the trigger detected by the trigger detection unit 132 and the parameter stored in the parameter storage area 142.

The flow computation unit 131 includes an instantaneous-flow computation unit 131a, an integrated-flow computation unit 131b, and a daily-report-data computation unit 131c. The instantaneous-flow computation unit 131a calculates the instantaneous flow. The integrated-flow computation unit 131b calculates a total integrated flow. The daily-report-data computation unit 131c calculates the daily report data.

The analog input unit 100 measures a flow related to the industrial apparatus to be controlled by the PLC 1 by using the flow meter, and collects measurement data. When an interval (a sampling period) at which the flow meter measures the flow is shorter than a period of the cyclic process by the CPU unit 200, it is difficult to perform an integration process in synchronization with the sampling period of the flow meter by the CPU unit 200.

Accordingly, in the present embodiment, the integration of the flow is performed by the analog input unit 100 that is configured to perform a high-speed data collection with respect to the sampling period of the flow meter, and the integration result is stored in the common memory 140. The flow data stored in the area of the common memory 140 is appropriately read out to the peripheral devices via the inter-unit bus 300 and the CPU unit 200.

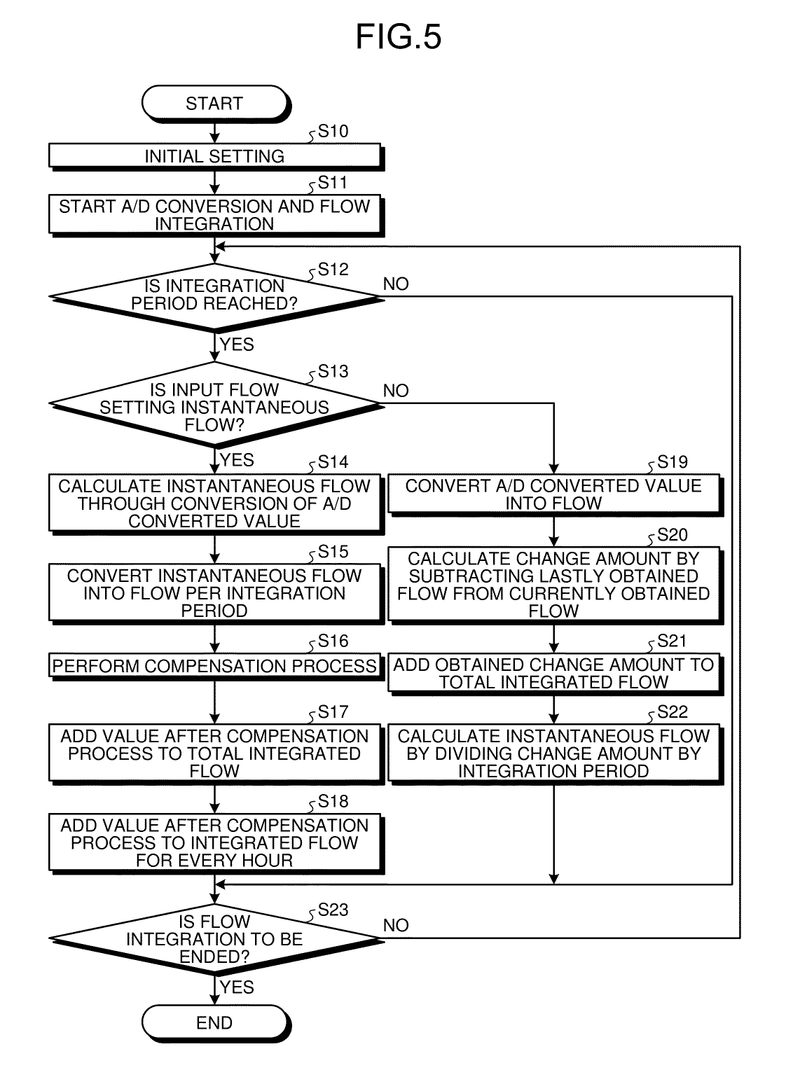

FIG. 5 is a flowchart for explaining an operation procedure of the analog input unit. The computation unit 130 performs an initial setting for performing an integration of a flow (Step S10). At this step, a setting on the integration of the flow performed by a user is acquired. Setting items include the input flow setting (an instantaneous value or an integrated value), the integration period, and the flow range of the flow meter. The user sets parameters of these items according to specifications and a setting of a flow meter to be connected.

When the A/D conversion by the A/D conversion unit 120 is started and when a request for starting the integration of the flow is received from the trigger detection unit 132, the flow computation unit 131 starts an operation of the integration of the flow (Step S11). To perform the integration of the flow for each integration period, the flow computation unit 131 determines whether the integration period is reached, by using a timer or a counter (Step S12).

When an elapsed time from Step S11 or from the last integration of the flow does not reach the integration period (NO at Step S12), the flow computation unit 131 continues to determine whether the integration period is reached (Step S12) unless there is a request for ending the integration of the flow (NO at Step S23). At the time when the elapsed time from Step S11 or from the last integration of the flow has reached the integration period (YES at Step S12), the flow computation unit 131 performs a process of integrating the flow.

The process of integrating the flow varies according to a type of the measurement value output from the flow meter. Therefore, the flow computation unit 131 determines whether the input flow setting in the initial setting is the instantaneous value (an instantaneous flow) or the integrated value (an integrated flow) (Step S13).

When the input flow setting is the instantaneous value (YES at Step S13), the flow computation unit 131 calculates the instantaneous flow through a conversion of the A/D converted value, and stores the calculated instantaneous flow in the flow storage area 143 (Step S14). The flow computation unit 131 uses, for example, the following equation to calculate the instantaneous flow.

Instantaneous flow=(upper limit of flow range)×(A/D converted value)/{(maximum value of A/D converted value in analog input unit)−(minimum value of A/D converted value in analog input unit)}

The flow computation unit 131 then converts the calculated instantaneous flow into a flow per integration period (Step S15). The flow computation unit 131 uses, for example, the following equation to calculate the flow per integration period.

Flow per integration period=(instantaneous flow calculated at Step S14)×(integration period)×(unit conversion value)

The unit conversion value is a parameter for converting the unit of time. For example, when a unit of the flow range of the flow meter is [/h] and a unit of the integration period is [ms], the unit conversion value for converting the flow in the unit of [/h] into the flow in the unit of [ms] is represented by the following equation. Unit conversion value=1/60 [min/h]×60 [s/min]×1000 [ms/s].

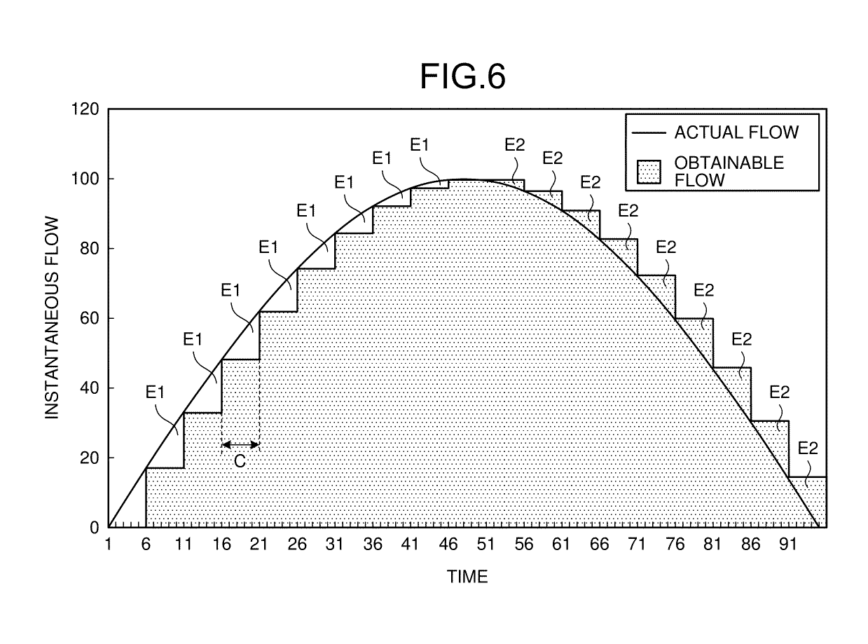

FIG. 6 is an explanatory diagram of errors that may occur due to an integration of a flow per integration period. In FIG. 6, the vertical axis represents the instantaneous flow, and the horizontal axis represents the time (both are in arbitrary units). When an actual flow in the flow meter changes during an integration period C, an error in the actual flow is included in a total integrated flow obtained by integrating the flow per integration period obtained at Step S15.

For example, when the flow has increased within the integration period C and if the flow per integration period obtained at Step S15 is integrated as it is, a deficiency error E1 occurs due to a fact that an increased amount of the flow in the integration period C is not added. On the other hand, when the flow has decreased within the integration period C and if the flow per integration period obtained at Step S15 is integrated as it is, a surplus error E2 occurs due to a fact that a decreased amount of the flow in the integration period C is added.

To minimize such errors, the flow computation unit 131 performs a process of compensating for the flow (Step S16). The flow computation unit 131, when there is a difference between the instantaneous flow in the last integration of the flow and the instantaneous flow in the current integration of the flow, assumes that the actual flow has changed during the period therebetween, and performs the compensation process.

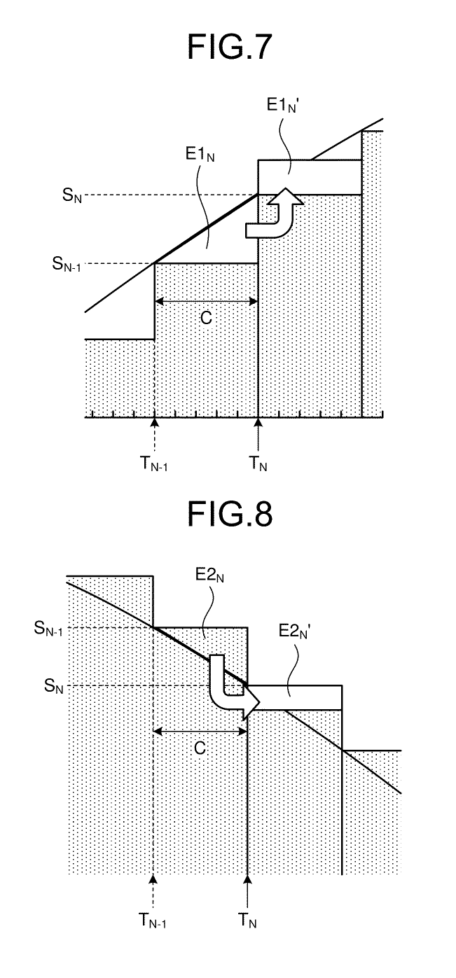

FIG. 7 is an explanatory diagram of a compensation performed when a flow has increased within the integration period. In this case, the flow computation unit 131 performs a compensation process of adding a flow corresponding to the increased amount in the integration period C to the flow for each integration period C. The flow computation unit 131 calculates the error by assuming that the actual flow is linearly changed within the integration period C.

For example, with respect to an instantaneous flow S_{N-1} at an integration timing T_{N-1}, when an instantaneous flow S_{N} has increased at the next integration timing T_{N} (S_{N-1}<S_{N}), the flow computation unit 131 calculates a deficiency error E1_{N} by using the following equation. The flow computation unit 131 adds a compensation amount E1_{N}′ corresponding to the deficiency error E1_{N} to the next calculated flow.

E1_{N}=(S_{N}−S_{N-1})/2

FIG. 8 is an explanatory diagram of a compensation performed when a flow has decreased within an integration period. In this case, the flow computation unit 131 performs a compensation process of subtracting a flow corresponding to the decreased amount in the integration period C from the flow for each integration period C.

For example, with respect to an instantaneous flow S_{N-1} at an integration timing T_{N-1} when an instantaneous flow S_{N} has decreased at the next integration timing T_{N} (S_{N-1}>S_{N}), the flow computation unit 131 calculates a deficiency error E2_{N} by using the following equation. The flow computation unit 131 subtracts a compensation amount E2_{N}′ corresponding to the deficiency error E2_{N} from the next calculated flow.

E2_{N}=(S_{N-1}−S_{N})/2

The flow computation unit 131 then adds a value obtained after the compensation process to the total integrated flow stored in the flow storage area 143 (Step S17). Furthermore, the flow computation unit 131 adds the value obtained after the compensation process to the integrated flow for every hour stored in the flow storage area 143 (Step S18). The order of Step S17 and Step S18 may be arbitrarily changed.

When the input flow setting in the initial setting is the integrated value (NO at Step S13), the flow computation unit 131 converts the A/D converted value into the flow (Step S19), and calculates a change amount by subtracting the lastly obtained flow from the currently obtained flow (Step S20). The flow computation unit 131 obtains the change amount of the flow obtained through the conversion of the A/D converted value as the flow per integration period.

The flow computation unit 131 then adds the change amount calculated at Step S20 to the total integrated flow stored in the flow storage area 143 (Step S21). Furthermore, the flow computation unit 131 adds the change amount calculated at Step S20 to the integrated flow for every hour stored in the flow storage area 143.

The flow computation unit 131 divides the change amount calculated at Step S20 by the integration period to convert the divided amount into an instantaneous flow for every integration period, and stores the converted instantaneous flow in the flow storage area 143 (Step S22). With this operation, when the measurement value output from the flow meter is the integrated value, the user can recognize not only the change in the integrated flow but also the change in the instantaneous flow.

After the integration process from Step S14 to Step S18 or from Step S19 to Step S22, the flow computation unit 131 continues the procedure from determination of whether the integration period is reached (Step S12) unless there is a request for ending the integration of the flow (NO at Step S23). When there is a request for ending the integration of the flow (YES at Step S23), the flow computation unit 131 ends the process of integrating the flow.

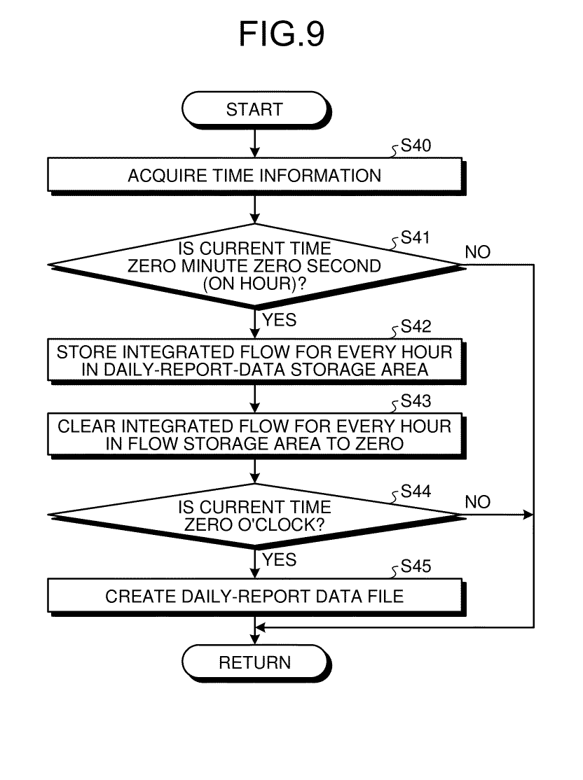

FIG. 9 is a flowchart for explaining a procedure performed from acquisition of the integrated flow for every hour to storage of the daily-report data file. The daily-report data file is created by reading the daily report data stored in the daily-report-data storage area 144 every day at a set time, for example, at 0 o'clock.

The flow computation unit 131 acquires time information of a sequencer CPU (Step S40), and determines whether the current time is on the hour (0 minute 0 second) (Step S41). When the current time is on the hour (YES at Step S41), the flow computation unit 131 reads out the integrated flow for every hour stored in the flow storage area 143 of the common memory 140, and stores the read out data in the daily-report-data storage area 144 of the common memory 140 (Step S42). Furthermore, the flow computation unit 131 clears the integrated flow for every hour of the flow storage area 143 to zero (Step S43). When the current time is not on the hour (NO at Step S41), the operation procedure is repeated from the start.

The flow computation unit 131 determines whether the current time is 0 o'clock (Step S44). When the current time is 0 o'clock (YES at Step S44), the flow computation unit 131 stores the daily report data for a day read out from the daily-report-data storage area 144 of the common memory 140 in a CSV file. The flow computation unit 131 creates a daily-report data file including the daily report data for a day read out from the daily-report-data storage area 144 (Step S45). After creating the daily-report data file, or when the current time is not 0 o'clock (NO at Step S44), the operating procedure is repeated from the start.

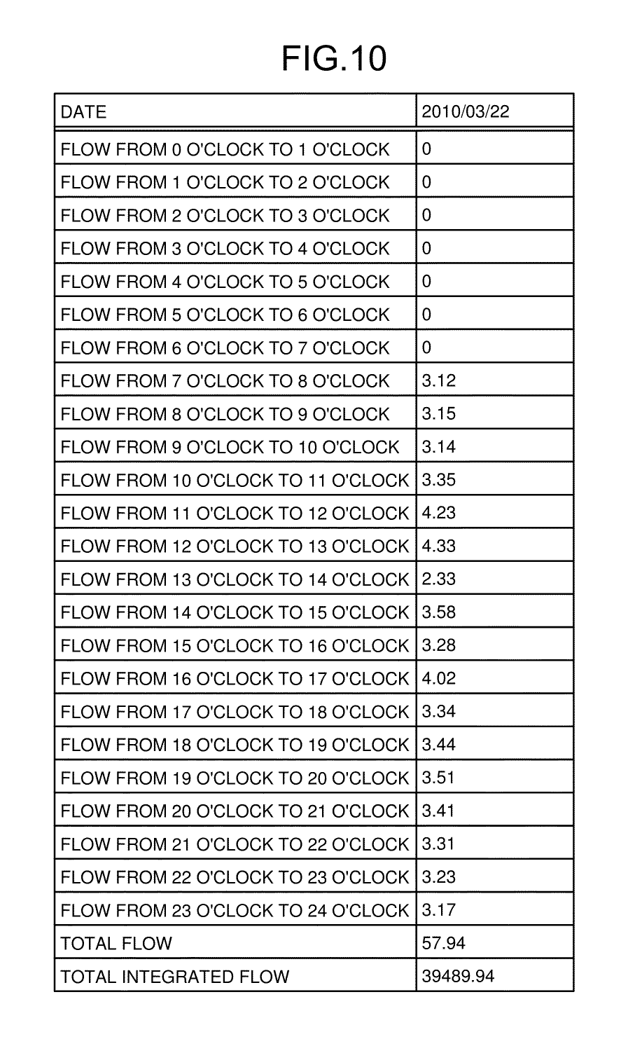

FIG. 10 is an example of the CSV file. In the CSV file, for example, the following information is written.
Date of the daily report data
Integrated flow for every hour
Total flow of a day
Total integrated flow since integration of flow is started.

Destinations to store the created daily-report data file are as follows, for example.
The internal memory 230 of the CPU unit 200
The memory card connected to the memory card I/F 210 of the CPU unit 200.

The created daily-report data file may be read out into the personal computer 2 connected to the PC I/F 240 of the CPU unit 200 and may be subject to instantaneous reference or processing. Alternatively, the daily-report data file may be read out by a daily-report-data reading tool that is operated on the personal computer 2 and displayed graphically.

The analog input unit 100 according to the present invention can load the flow data to the PLC 1 while utilizing a high speed and a high periodicity of the analog input unit 100, by calculating the instantaneous flow and the total integrated flow by the flow computation unit 131. Furthermore, the analog input unit 100 can easily create the daily report data that can be used for flow management and abnormality detection by the PLC 1, by reading out the integrated flow for every hour stored in the common memory 140. The PLC 1 can use the daily-report data file that is automatically created and stored in the system. This enables the PLC 1 to easily perform the flow management and the abnormality detection.

### INDUSTRIAL APPLICABILITY

As described above, the analog input unit and the programmable controller according to the present invention are suitable in a case where flow management is performed or occurrence of an abnormality in an industrial apparatus to be controlled is monitored.

### REFERENCE SIGNS LIST

1 PLC
2 personal computer
3 memory card slot
100 analog input unit
110 analog-data input I/F
120 A/D conversion unit
130 computation unit
131 flow computation unit
131a instantaneous-flow computation unit
131b integrated-flow computation unit
131c daily-report-data computation unit
132 trigger detection unit
140 common memory
141 A/D-converted-value storage area
142 parameter storage area
143 flow storage area
144 daily-report-data storage area
150 trigger input I/F
160 bus I/F
170 internal bus
200 CPU unit
210 memory card I/F
220 computation unit
230 internal memory
240 PC I/F
250 bus I/F
260 internal bus
300 inter-unit bus

1. An analog input unit configured to be included in a programmable controller and to sequentially convert analog values input from outside into digital values, the analog input unit comprising:
an analog-to-digital conversion unit that converts an analog value being a measurement value of a flow meter into a digital value;
a flow computation unit that calculates an instantaneous flow and a total integrated flow that is obtained by integrating a flow per setting time set in advance, based on the digital value from the analog-to-digital conversion unit; and
a storage unit that includes a flow storage area for storing therein the instantaneous flow and the total integrated flow calculated by the flow computation unit.

2. The analog input unit according to claim 1, wherein when the flow meter outputs an instantaneous value as the measurement value, the flow computation unit calculates the instantaneous flow through a conversion of the digital value from the analog-to-digital conversion unit, and converts the calculated instantaneous flow into a flow per the setting time.

3. The analog input unit according to claim 1, wherein when the flow meter outputs an integrated value as the measurement value, the flow computation unit obtains a change amount of a flow obtained through a conversion of the digital value from the analog-to-digital conversion unit as a flow per the setting time, and converts the change amount into the instantaneous flow for the every setting time.

4. The analog input unit according to claim 1, wherein when a flow in the flow meter is increased within the setting time, the flow computation unit performs a compensation of adding a flow corresponding to an increased amount within the setting time to the flow per the setting time, and when a flow in the flow meter is decreased within the setting time, the flow computation unit performs a compensation of subtracting a flow corresponding to a decreased amount within the setting time from the flow per the setting time.

5. The analog input unit according to claim 1, wherein the storage unit further includes a daily-report-data storage area for collecting a flow per hour in units of day.

6. The analog input unit according to claim 5, wherein the flow computation unit creates a daily-report data file including data for a day read from the daily-report-data storage area.

7. A programmable controller comprising:
an analog input unit that sequentially converts analog values input from outside into digital values; and
a CPU unit connected to the analog input unit via an inter-unit bus, wherein
the analog input unit includes
an analog-to-digital conversion unit that converts an analog value being a measurement value of a flow meter into a digital value,
a flow computation unit that calculates an instantaneous flow and a total integrated flow that is obtained by integrating a flow per setting time set in advance, based on the digital value from the analog-to-digital conversion unit, and
a common memory unit that includes a flow storage area for storing therein the instantaneous flow and the total integrated flow calculated by the flow computation unit and is accessible by the CPU for a read operation.
